(19) United States
(12) Patent Application Publication
(10) Pub. No.: US 2011/0272334 A1
(43) Pub. Date: Nov. 10, 2011

(54) COLLECTED RAIN WATER CLASSIFIER AND DIVERTER

(76) Inventor: Antonio Garios Wadih, Juiz De Fora - Minas Gerais (BR)

(21) Appl. No.: 13/142,846

(22) PCT Filed: Dec. 23, 2009
(86) PCT No.: PCT/BR2009/000438

§ 371 Date: Jun. 29, 2011

(30) Foreign Application Priority Data
Dec. 30, 2008 (BR) PI0805562-9

(51) Int. Cl. C02F 1/00

(52) U.S. Cl. 210/96.1

(57) ABSTRACT

A classifier and separator of collected pluvial water based on the turbidity, including a receptor and conductor pipe of pluvial water (1), by a part of tubing (4) made to measure the turbidity, consisted by a light emitting font (2) and by a luminosity sensor (3), connected to a central control module (5) that commands the starter (6) and that moves the passage valve (7) heading the water for to directions: exit (8) or exit (9).

The current patent of invention refers to classifier and separator of collected pluvial water, picked from roofs, coverings, big rain collector areas, etc. Thanks to its special constructive characteristics and of utilization, it stands out in an efficient and practical way.

Through a system that involves a light emitting source, and a submerged luminosity receptor into the water, the sensor picks up the light of the source in a certain distance, valuing the transparence of the environment, determining with this measurement the quality of the water according to the turbidity, this way, classifies and separates the water to be analyzed.

Nowadays there are many process to collect and save the rain, for example: in places where we can find good technologies, the water passes by some filters and sometimes by other equipments in the circuit, until it gets to the deposit to be used.

In other collection systems, the first waters of the rain are headed manually until they get cleaned to the bare eyes and soon they are redirected to the deposit of usage. However, these systems don't work properly according to the turbidity system and the cleaning of the dirt that comes in the first moments with the water of the rain, mainly those that come after a long period without rain.

The first waters of the rain have a lot of dirt that accumulates with the time and they are taken by the rains to the captation system, damaging the captation systems, components and the health of those that use them. A dark water (that has suspended solids thinly divided or in a colloidal state, and of microscopic organisms) besides being visually undesirable, is dangerous.

The disinfection of the water and mainly the inactivation of the virus and microorganisms are more efficient according to the less turbidity of the water.

Through the proposal to solve problems described above and many others, and with the proposal to overcome them, the classifier and separator of pluvial water was developed, the main goal of this patent, being sure that this system classifies and separates precisely the first waters of the rain, and any other, at any moment out of the patterns stipulated of the turbidity, having as a characteristic being efficient when eliminating the dark dirt waters (first waters of the rain), and having a low cost of producing and maintenance.

The classifier and separator of pluvial water, the main goal of the patent of invention, can be better comprehended though the following detailed description, according to the picture annexed.

Picture1. Shows a side view, with indication of the water in the system and a draw describing the patent of invention.

Describing in details the invention according to the picture 1, that follows the descriptive report, the classifier and separator of pluvial water is consisted by a tube (1) where the collected water passes by received by the captation surfaces or collectors like roofs, coverings, etc, starting the captation of the waters by the entrance (10), this way the waters carry all the dirt that were deposited along the time in the collector surface, passing by a part of the tubing (4) where the turbidity is measured, though the light emitting source (2) directed through the water to the luminosity sensor (3) which sends a signal of the light intensity that crosses this water to the central control module (5), where is made the reading of part of the system, and where the water is classified and separated. The central control module (5) becomes a mere divider of the waters, commanding the actuator (6) that will start the flow valve (7) directing the disqualified waters—the dirt ones—generally the first waters of the rain to the exit (8) and the qualified waters to the exit (9).

From this point, from the exit (9), the qualified water must pass by several equipments like filters, chlorine reagents and the like, if they exist, and after, to the deposit, valves, pumps, etc. As the dark waters were eliminated from the beginning, there is no damage for the system and for those that will use it.

The part of the tubing (4) where the turbidity is measured, is properly located, structured and built with the proposal to get an accurate measurement.

The measurement of reference of the turbidity for the system is got by a chosen sample of water as a pattern, that can be the treated water of the region or any other chosen water. It is put in the system where this value is registered. Based on this measurement of reference of turbidity, the central control module (5) classifies and separates the pluvial waters automatically disqualifying the waters of turbidity over the sample, those dirt ones, usually those waters picked up in the first moments of the rain, in the moment of the cleaning of the roofs, gutters, canalization and also the dirt water with dust when it is raining. Those waters with the turbidity above the pattern stipulated are sent to the exit (8). The classified waters, with turbidity values like or under the sample, “clean waters”, will certainly sent to the exit (9).

We still have in the picture 1, the number (11) representing one of the parts of the surface of the caption, and the number 12 that represents that rain.

1- “CLASSIFIER AND SEPARATOR OF COLLECTED PLUVIA WATER” characterized by being constituted by a water conducting pipe (1), through which passes the pluvial water collected from the areas of reception by a part of the piping (4) adequately constructed to measure the turbidity by a light emitting source (2), directed through the water to the luminosity sensor (3) that collects the emission of the light, sending a signal to the command module (5) that analyzes the data, classifies and separates the water, commanding the actuator (6) that commands the flow valve (7) directing the water to two positions: outlet (8), with turbidity higher than that stipulated and outlet (9) with turbidity lower than or equal to that of the chosen sample.
